(19) United States
(12) Patent Application Publication
(10) Pub. No.: US 2004/0183656 A1
(43) Pub. Date: Sep. 23, 2004

(54) Display unit

(76) Inventors: Heinz-Bernhard Abel, Grossostheim (DE); Heinrich Noll, Gross-Umstadt (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/486,954

(22) PCT Filed: Aug. 1, 2002
(86) PCT No.: PCT/DE02/02846

(30) Foreign Application Priority Data
Aug. 15, 2001 (DE) 10138849.7

(51) Int. Cl. B60Q 1/00

(52) U.S. Cl. 340/425.5; 345/7; 359/13

(57) ABSTRACT

The invention relates to a display unit comprising a first display (3) with a dial face (4) and a pointer (5). In front of said first display (3), on the side facing the observer, a second display (7) is disposed and is transparent when not activated. Said second display is adapted to display information and is configured as a self-emitting display with negative representation. The second display (7) is a structural component that comprises an organic light-emitting substance (OLED).

The invention pertains to a display unit, especially for a motor vehicle, which has a first, analog, display with a dial and a pointer and a second, digital, display, which, when actuated appropriately, is visible to the observer from the same angle as that from which the dial is visible.

Display units of the type indicated above are known as bi-vision combination instruments in motor vehicles, for example, and they allow information to be shown on the display plane of the analog display. In the known display units, this is done by the setting up a beam splitter so that, from the observer's perspective, it is in front of the first display and also at an angle to it. In addition, the cover glass of the display unit in question or the beam splitter must also be tinted, so that only the information on the desired display becomes visible (“black panel effect”). The need for the slanted beam splitter leads to an undesirably bulky design and also means that a great deal of technical effort must be expended to illuminate the two displays. The tinting of the cover glass or of the beam splitter, furthermore, calls for high light intensities and thus leads to the disadvantageous development of heat.

The invention is based on the problem of designing a display unit of the type indicated above in such a way that it is especially compact and can be produced at low cost.

This problem is solved according to the invention in that the second display is a transparent display, which is set up in front of and parallel to the plane of the dial on the side facing the observer, and in that it is designed as a self-emitting display for presenting the information.

In a display unit of this type, the second display is transparent when not actuated, so that the dial and the pointer of the first display can be seen without hindrance. When the second display is actuated, the actuated areas become opaque, so that only this second display can then be seen in these areas. Because the second display is parallel to the plane of the first display, in contrast to the beam splitter in the known, comparable display units, the depth of the display unit is much smaller. Depending on the design of the dial and of the cover glass, the invention makes it possible for the display unit to be designed either with or without a black panel effect.

It is advantageous for the display to present its information in negative form, because then, when the display is actuated, the dial behind it is necessarily concealed.

In accordance with an elaboration of the invention, it is especially advantageous for the second display to have an organic light-emitting substance. Such displays with organic substances are superior to inorganic light-emitting displays because they require less energy to produce the same light intensity.

At present, organic, light-emitting substances in the form of monomers and polymers are known. For applications in display units for motor vehicles, it is especially advantageous and inexpensive to base the design of the second display on a polymer.

A display unit of especially simple design can be obtained by setting up the second display so that, from the perspective of the observer, it is in front of the pointer and serves as the cover glass at the same time. A design of this type is especially suitable for combination instruments, because it means that the instrument can be either equipped with the second display or not. In addition, the need for a separate cover glass is eliminated.

For the mass production of display units with an analog first and a digital second display, it is especially favorable for cost reasons according to another elaboration of the invention for the second display to be located directly in front of the dial and for the pointer to consist of a transparent, organic light-emitting material located in front of the second display.

An especially effective and easy way to illuminate the dial is to make the graphics on the dial translucent and to provide transmittent illumination behind the dial.

An especially uniform and energy-saving way to illuminate the dial is to provide the transmittent illumination in the form of a 2-dimensional, organic light-emitting component.

A black panel effect can be easily achieved by tinting the translucent dial dark. As a result, the dial becomes invisible when the second display is not being actuated, even if the cover glass is only slightly tinted.

The invention also gives the designer more freedom in designing display units. For example, it is possible in particular for the second display to cover only part of the dial.

The invention can be realized in various forms. To explain the basic principle of the invention in greater detail, a schematic diagram of it is shown in the drawing, which will be described below. This diagram shows a longitudinal cross section through a display unit according to the invention.

The display unit shown has a housing 1, which is covered at the front, i.e., on the side facing the observer, by a cover glass 2. The first display 3 is installed at the rear of the housing 1; it is of analog design and has a darkly tinted dial 4 and a pointer 5, which can consist of a transparent, organic light-emitting material. The dial 4 is translucent and has, for example, a transparency of 40%. For this reason, transmittent illumination 6 can be located behind the dial 4, this illumination being in the form of a 2-dimensional, organic light-emitting component (OLED).

Between the dial 4 and the pointer 5, a second digital display 7 is located, which is preferably also designed as an organic light-emitting component. When not being actuated, this second display 7 is transparent. When actuated to show information, however, it functions as a self-emitting display of the negative type. In the present example, the second display has an opening to accommodate the axis of the pointer. With respect to the provision of this opening, it is especially advantageous for the OLED display to be made of plastic. The pointer 5 does not have to be installed in front of the second display 7. It would also be possible for the second display 7 to be located in front of the pointer 5, i.e., on the side facing the observer. Then a completely conventional pointer instrument could be used as the first display 3. It would then also be possible to eliminate the cover glass, because the second display 7 would itself assume the function of the cover glass.

1. Display unit, especially for a motor vehicle, which has a first, analog, display with a dial and a pointer and a second, digital, display, which, when actuated appropriately, is visible to the observer from the same angle as that in which the dial is visible, characterized in that the second display (7) is a transparent display, which, from the perspective of the observer, is located in front of and parallel to the plane of the dial (4) and is designed as a self-emitting display for presenting information.

2. Display unit according to claim 1, characterized in that the display is designed to present information in negative fashion.

3. Display unit according to claim 1 or claim 2, characterized in that the second display (7) has an organic light-emitting substance.

4. Display unit according to at least one of the preceding claims, characterized in that the second display (7) has a polymer.

5. Display unit according to at least one of the preceding claims, characterized in that, from the perspective of the observer, the second display (7) is located in front of the pointer (5) and thus also forms the cover glass at the same time.

6. Display unit according to claim 5, characterized in that the second display (7) is made of plastic and has at least one opening.

7. Display unit according to claim 4, characterized in that the second display (7) is located directly in front of the dial (4), and in that the pointer (5) consists of a transparent, organic light-emitting material and is located in front of the second display (7).

8. Display unit according to at least one of the preceding claims, characterized in that the graphics of the dial (4) are translucent, and in that transmittent illumination (6) is provided behind the dial (4).

9. Display unit according to claim 8, characterized in that the transmittent illumination (6) is in the form of a 2-dimensional, organic light-emitting component.

10. Display unit according to at least one of the preceding claims, characterized in that the translucent dial (4) is tinted dark.

11. Display unit according to at least one of the preceding claims, characterized in that the second display (7) only partially covers the dial (4).
